(19) United States
(12) Patent Application Publication
(10) Pub. No.: US 2025/0167489 A1
(43) Pub. Date: May 22, 2025

(54) Universal Electrical Connection Device for a Battery Box and/or a Battery

(71) Applicant: Zedel, Crolles (FR)

(72) Inventors: Raphael Bortolotti, Annecy le Vieux (FR); Jerome Carrier, Annecy (FR); Pascal Orchampt Aquilina, La Combe de Lancey (FR)

(21) Appl. No.: 18/955,192

(22) Filed: Nov. 21, 2024

(30) Foreign Application Priority Data
Nov. 21, 2023 (EP) 23315436.8
Feb. 15, 2024 (EP) 24157980.4

(51) Int. Cl. H01R 13/627; H01R 13/629

(52) U.S. Cl. CPC H01R 13/6271; H01R 13/62911

(57) ABSTRACT

A device for recharging a battery is described, including a connector (60) provided with three electrical contacts arranged linearly and two jaws having at their ends a cylindrical surface intended to clip onto a battery/case. The connector includes three electrical contacts (61, 62, 63) arranged linearly with the middle contact located at an equal distance from the two jaws. The battery/case includes two left and right side faces each comprising a recess with a hooking profile (55, 56) configured by each corresponding jaw of said connector (60). The battery includes three electrode terminals arranged linearly and configured to allow an electrical connection with each of the three contacts (61, 62, 63) of said connector (60), in which the middle electrode (52) carries a voltage representative of the temperature of the battery.

### RELATED PATENT APPLICATION

This application is related to U.S. patent application Ser. No.______, which is incorporated by reference herein in its entirety, and assigned to a common assignee.

### TECHNICAL FIELD OF THE INVENTION

The present invention relates to the field of portable electric lamps and in particular a universal electrical connection device for a system for recharging a battery of a headlamp.

### BACKGROUND ART

Portable headlamps often have a housing for rechargeable or non rechargeable batteries, internal or external depending on whether the weight of these batteries is to be transferred to the rear of the headlamp.

As the weight of batteries increases and the conditions of use become harsher, it is important to have a battery case that provides a secure and waterproof housing for the battery.

### SUMMARY OF THE INVENTION

It is also desirable to have a high-performance charging system, particularly in terms of the speed and ease of charging for the user and this in any possible configuration.

It is an object of the present invention to propose an electrical connection device for a battery housing case of a headlamp offering various charging possibilities and configurations.

It is another object of the present invention to provide a universal electrical connection device allowing several charging configurations, including direct charging of a battery, outside the headlamp, or even charging of this same battery once housed in its housing case of the headlamp.

It is a third object of the present invention to provide a battery charger comprising an electrical connection device that allows connection and charging regardless of the direction of connection of the charging connector.

It is a fourth object of the present invention to propose an electrical connection device allowing rapid charging of a battery even when housed inside a housing of a headlamp.

The present invention achieves all these goals by realizing a device for connecting a battery charging system comprising a connector provided with three electrical contacts arranged linearly and further comprising two flexible jaws having at their end a cylindrical surface intended to clip onto the upper part of a battery or a battery case. The middle contact is arranged at an equal distance from the two jaws. A battery/battery case comprising two left and right side faces each comprise a recess with a hooking profile matching one jaw of said connector.

Each hooking profile of the two recesses comprises two substantially planar surfaces substantially forming a re-entrant angle, and which are connected by means of a semi-circular groove whose generating axis is parallel to the upper edge of the left and right side faces. The semi-circular groove also provides a support line for said cylindrical surface of a corresponding jaw, so as to allow clipping of the connector either by via a left clipping or via a right clipping.

In an alternate embodiment, one among the first or second terminal is configured to transmit to the charger a voltage representative of the temperature of the battery and the other two terminals are then configured to transmit two positive and negative voltages. The charging module comprises electronic circuitry including detection circuits and switching circuits for allowing the user to couple the connector either from the right position or from the left position. Such arrangements is very advantageous since it allows to delocalize the battery management circuitry outside the battery case/battery, thus avoiding the need to evacuate a huge amount of heat which would otherwise has been generated inside a sealed case, thus slowing down the charging process.

### DESCRIPTION OF THE DRAWINGS

Other characteristics, purpose and advantages of the invention will appear on reading the description and the drawings below, given solely as non-limiting examples. In the attached drawings:

FIGS. 1a and 1b show two front and rear perspective views of a housing body intended to house an electric battery according to one embodiment.

FIGS. 2a and 2b illustrate two perspective views, front and rear, of a housing cover according to the present invention, comprising a three-pole electrical connector.

FIGS. 3a and 3b illustrate two perspective views, front and rear, of a locking lever for the housing cover.

FIG. 4a is a view showing a headlamp comprising a housing, its cover and the locking lever mounted on a support.

FIG. 4b is a section of the headlamp along the CAM-CAM axis of FIG. 4a.

FIG. 5a is a section along the LEVER-LEVER axis of FIG. 4a.

FIG. 5b is a section along the AX-LEVER-AX-LEVER axis of FIG. 5a.

FIGS. 6a, 6b and 6c show three illustrative sections of the locking of the cover by means of the locking lever, illustrating the engagement of the semi-circular key in the corresponding circular groove.

FIGS. 7a, 7b and 7c illustrate three phases of the opening of the housing cover also comprising a three-pole electrical connector according to the invention.

FIG. 8a illustrates a front perspective of the battery housing/case in which a battery is inserted.

FIG. 8b illustrates a front perspective of a battery according to the present invention.

FIGS. 9a, 9b and 9c illustrate three perspective views of a connector according to one embodiment of the present invention, adapted to allow a connection to the housing or directly to the battery.

FIGS. 10a, 10b and 10c illustrate three successive phases of an electrical connection of an electrical connector on the housing by “the left”.

FIGS. 11a, 11b and 11c illustrate three successive phases of an electrical connection of the electrical connector on the housing “by the right”.

FIGS. 12a, 12b and 12c illustrate three successive phases of an electrical connection of the electrical connector to the battery “by the left”.

FIGS. 13a, 13b and 13c illustrate three successive phases of an electrical connection of the electrical connector to the battery “by the right”.

FIGS. 14a, 14b and 14c illustrate a section of the housing with the battery, as well as two detail views A and B, respectively.

FIG. 15a illustrates the CONNEC-CONNEC view of the housing with the battery, as well as the definition of a section Y_0.

FIG. 15b illustrates the section Y_0-Y_0 defined in FIG. 15a.

FIG. 15c illustrates a detail C of FIG. 15b.

FIGS. 16a, 16b and 16c illustrate respectively a section of the connection connector connected to the housing with the battery, as well as two details D and E respectively.

FIGS. 17a, 17b, 17c and 17d respectively illustrate the same sections as those of FIGS. 15a, 15b, and 15c, but with the connector connected to the battery housing, with two detailed views G and F.

FIG. 18 illustrates a first embodiment of the electronic circuits of the charging system associated with the battery.

FIG. 19 illustrates a second embodiment of the electronics of the charging system associated with the battery.

FIG. 20 illustrates a third embodiment of the electronic circuits of the charging system associated with the battery.

### DESCRIPTION OF THE PREFERRED EMBODIMENTS

A general description will be given of a housing intended to serve as a housing for a rechargeable/non rechargeable battery as well as an electrical connection device of a connector intended to recharge this same battery according to various configurations.

In order to reduce the weight of the load carried at the front of the user's head, the rechargeable/non-rechargeable battery housing is designed to be transferred to the back of the user's head in order to power a headlamp electronic circuit located at the front of the latter. It should be noted, however, that this is only a particular embodiment and that the connection device of the present invention cannot be limited to headlamps having an external battery case. Clearly, the innovative locking system that will be described in detail can be implemented within a single-piece headlamp comprising both the lighting system and an internal battery compartment.

More generally, the housing and its locking system are designed completely independently of the LED lighting system and its associated electronics. Consequently, the battery case which will be described can be associated with any lighting system whatsoever, from the simplest to the most sophisticated, such as, for example, that of lighting integrating a REACTIVE LIGHTING type technology marketed by the company PETZL.

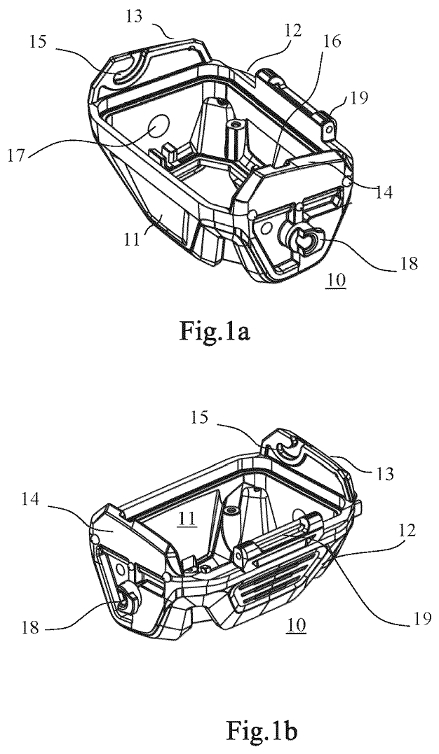

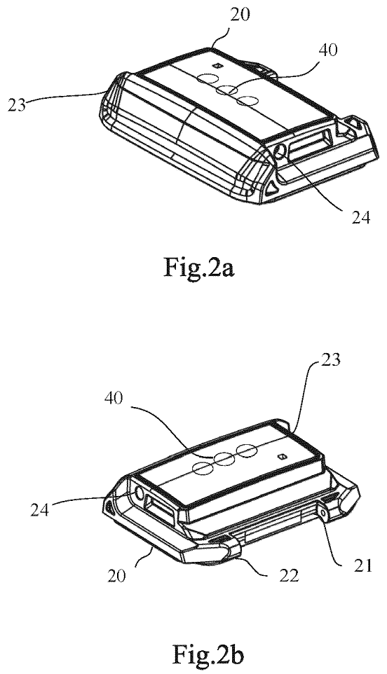

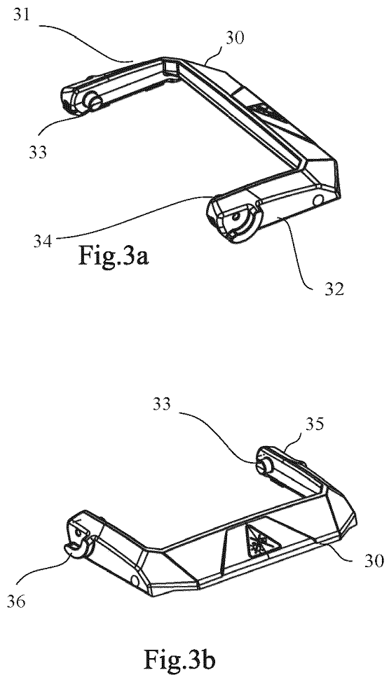

In general, the battery case according to the present invention comprises three constituent elements which are respectively illustrated in FIG. 1a/1b, 2a/2b and 3a/3b, namely:
a housing body 10 (FIGS. 1a and 1b);
a housing cover 20 (FIGS. 2a and 2b);
a locking lever 30 (FIGS. 3a and 3b) specifically designed to allow the locking of the cover 20.

The housing case according to the invention comprises a housing body 10 of substantially parallelepipedal shape-illustrated in the two front and rear perspectives of FIGS. 1a and 1b respectively and intended to receive a housing for a non-rechargeable or rechargeable battery.

In this regard, the housing body 10 comprises a front face 11, a rear face 12 and two left 13 and right 14 side faces delimiting by means of an associated bottom a housing for an electric power supply battery, being rechargeable or not. The rear face 12 comprises, at its upper rear edge, a connection system 19 with a cover 20, of the hinge type, allowing the rotation of the cover 20 relative to a first axis of rotation substantially parallel to the upper rear edge of the face 12 of the housing.

In a particular embodiment, the hinge is assembled at the housing by means of two blind holes materializing the first axis of rotation and configured to receive two rods/pins of the cover 20 which will be described later in relation to FIGS. 2a and 2b.

The axis of the hinge 19, as well as the left 13 and right 14 lateral faces project relative to the upper edges of the front 11 and rear 12 faces, as shown in FIGS. 1a and 1b.

Each of the left 13 and right 14 lateral faces comprises, at the front part of the housing, a groove (resp. 15, 16) of substantially circular shape, centered on a point defining a second axis of rotation, the functionality of which will be described later.

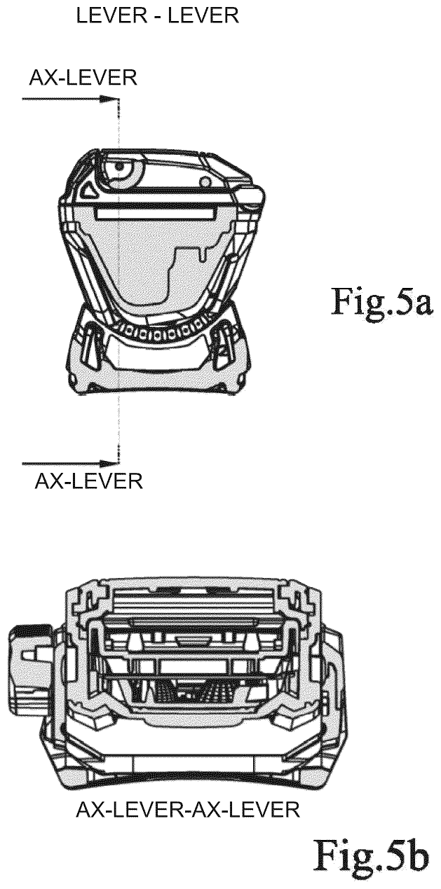

Finally, the housing comprises near the middle of the left and right side faces two pivot elements 17 and 18 producing a third axis of rotation 17-18, around which the housing can describe a rotational movement relative to a fixed support not illustrated in FIGS. 1a and 1b, but represented in FIGS. 5, 6, 7 and 8a.

Cover 20 will now be described, with reference to FIGS. 2a and 2b, which is configured so as to close, in a waterproof and sealed manner, the housing of FIGS. 1a and 1b. Generally speaking, the cover 20 comprises an upper face provided with a three-pole connector 40 which will be described later, two front and rear faces as well as two left and right side faces.

In a particular embodiment, the cover 20 comprises, at its rear face, two blind holes 21 and 22 intended to receive a rotation rod (not described) for producing a pivot connection between the cover 20 and the housing body 10 thus materializing the hinge-type connection 19 mentioned above.

Opposite the holes 21 and 22, the cover 20 also comprises on the left and right side faces, close to the front face, two circular holes, respectively 23 and 24, materializing the second axis of rotation mentioned above, and configured to receive two pins 33 and 34 located on the two ends of a U-shaped lever 30, so as to allow its rotation around the second axis of rotation located at the front of the cover 20. The lever 30, illustrated in FIGS. 3a and 3b, is configured so as to perfectly match the shape and profile of the cover 20 when the latter is in a horizontal plane, finalizing the locking process.

The U-shaped lever 30 is illustrated more specifically in FIGS. 3a and 3b and comprises respectively two branches 31 (left) and 32 (right). The inner face of the branch 31 has at its end a first perpendicular pin 33 while the branch 32 has on its inner face a second pin 34 also at its end. The two pins 33 and 34 are intended to be inserted into the blind holes 23 and 24, respectively of cover 20 so as to achieve the pivot connection of the lever 30 relative to the cover 20 along the second axis of rotation.

The U-shaped lever 30 also has, on each of the two external faces of the branches 31 and 32, a semi-circular cam, 35 and 36 respectively, having a substantially circular shape around an axis common with the second axis of rotation.

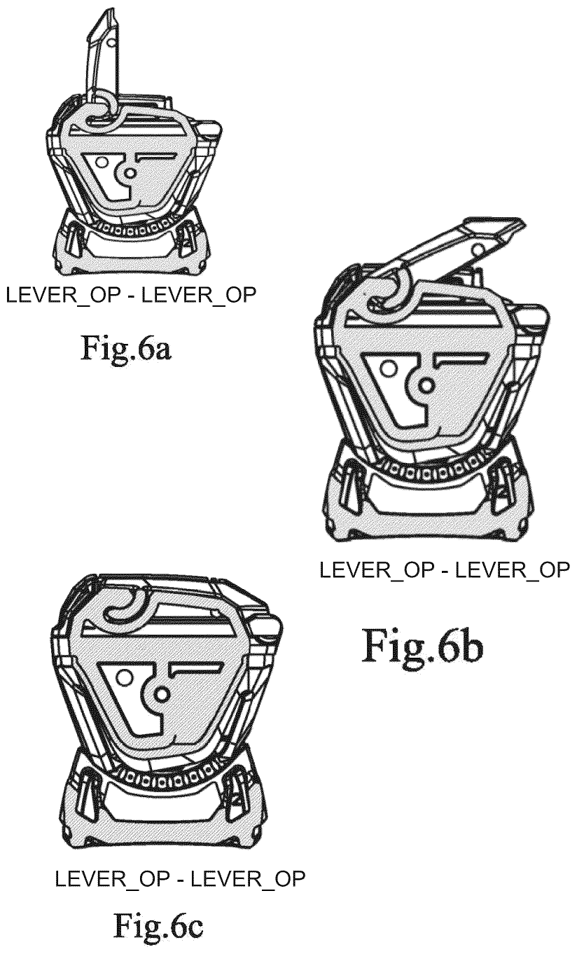

Correspondingly, the side faces 13 and 14 of the housing body 10 comprise, at the level of the front part, two circular grooves 15 and 16 configured to receive the engagement of the semi-circular cams 35 and 36, respectively, when the cover is in the closed position with the lever being in a vertical plane as illustrated in FIG. 6a, and when the lever is lowered to the right to bring it into a horizontal plane (FIG. 6b and FIG. 6c), what causes the insertion of the semi-circular cams 35/36 into their respective circular grooves 15 and 16 and ensures force locking thanks to the cooperation between the semi-circular cams 35/36 and the circular grooves 15/16.

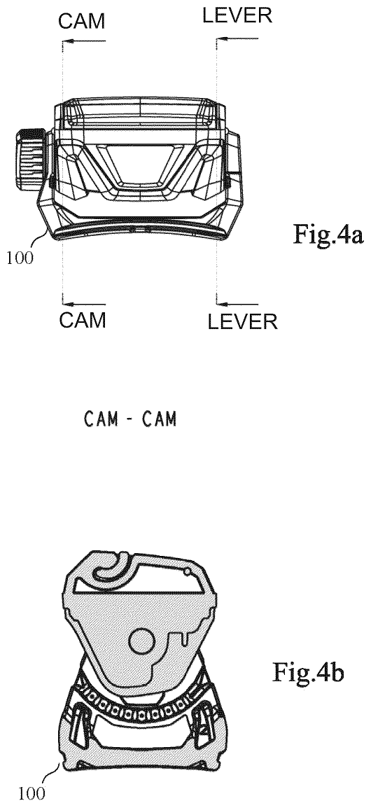

FIG. 4a is a view showing a headlamp comprising a housing, its cover and the locking lever mounted on a support 100. Two sectional views, respectively CAM-CAM and LEVER-LEVER are defined therein.

FIG. 4b is a sectional view of the headlamp along the CAM-CAM axis of FIG. 4a. It clearly shows the engagement of the cam 35 inside the circular groove 15 of the lateral face 13.

FIG. 5a is a sectional view along the LEVER-LEVER axis of FIG. 4a, also highlighting a AX-LEVER-AX-LEVER sectional view, the detail of which is illustrated in FIG. 5b.

FIGS. 6a, 6b and 6c show three illustrative sections of the cover locking by means of the locking lever, this locking lever being represented in three different positions: open, semi-open, and closed (locked).

Starting from FIG. 6a, the user can exert pressure on the cover while starting to pivot the lever around the second axis of rotation so as to make the circular cams 35/36 enter their corresponding circular grooves 15/16. By lowering the lever to the end of the insertion—FIG. 6b—the user can close the housing securely and perfectly tightly thanks to the combination of the internal seals in the cover 20 (not shown), and the pressure exerted by the cooperation of the circular cams 35/36 in their corresponding circular grooves 15/16.

It can thus be seen that lowering the lever makes it possible to achieve the assembly described above with the engagement of the cams 35/36 into their corresponding circular grooves 15/16, so as to ensure tight and effective closing of the cover. It will be noted in particular that sealing can be achieved by means of one or more seals arranged on the cover, the details of which are not part of the present invention.

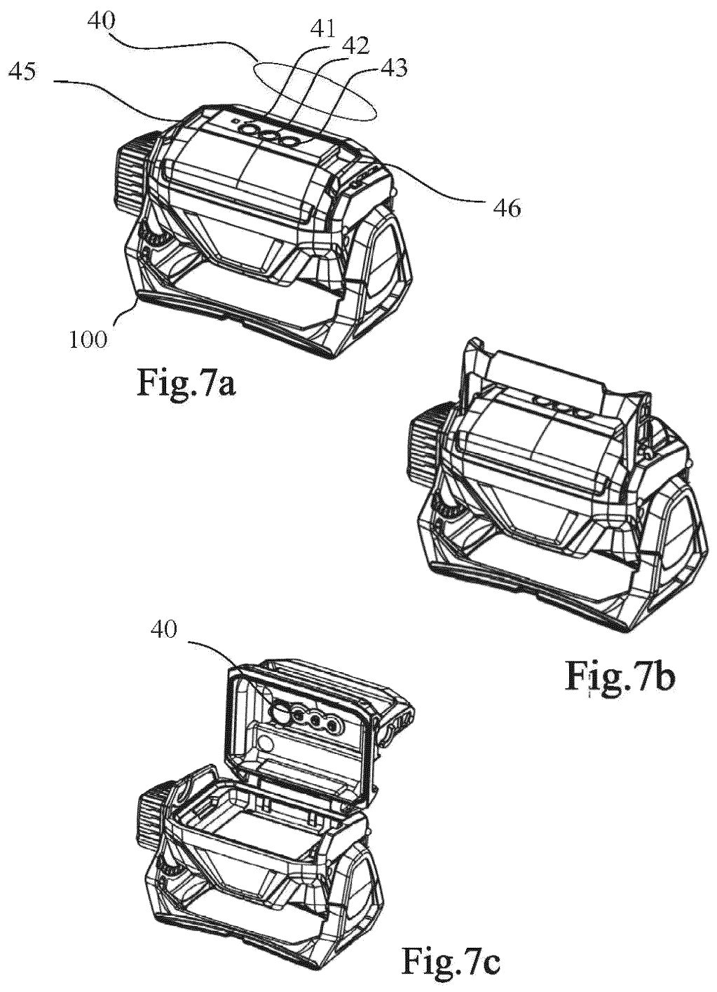

FIGS. 7a-7c illustrate three perspective views showing steps of unlocking and opening the cover. In FIG. 7a, the housing body 10 is closed with its cover completely locked by the U-shaped lever 30 arranged in a horizontal plane. In FIG. 7b, the user has pivoted the U-shaped lever 30 to bring it into a vertical plane, thereby disengaging and releasing the circular cams 35/36 from their corresponding groove 15/16 so as to allow the rotation of the cover 20 about the first axis of rotation and, consequently, the opening of the housing case. In FIG. 7c, the housing is completely open with its cover in a parallel plane, which allows the user to release the electric battery pack present in the housing case or to insert a new one.

More detail is given for the three-pole electrical connector 40 arranged on the upper face of the cover 20, also on the upper face of the battery pack 200, allowing the latter to be recharged, whether or not it is housed in the housing 20.

The electrical connection device according to the invention is based on a specific connector 60 described later, and especially on the combination of two particular arrangements present both on the upper face of the cover 20 of the housing body 10 and on the upper face of the battery 200, namely:
a) a set of two perfectly symmetrical attachment profiles 45 and 46 on the housing body 10 (resp. 55 and 56 on battery 200) respectively arranged in the upper part of the left and right side faces and allowing easy clipping/unclipping of a jaw of a specifically profiled connector 60; and
b) a three-pole connector 40 on the upper face of the housing case (resp. 50 on the upper face of the battery 200) comprising a first electrode terminal 41 on the cover 20 (resp. 51 on battery 200), a second electrode terminal 42 on the cover 20 (resp. 52 on battery 200) and a third electrode terminal 43 on the cover 20 (resp. 53 on battery 200) arranged linearly, in which the terminal 42 (resp. 52) is a central terminal arranged at an equal distance from the two attachment profiles 45 and 46 (resp. 55 and 56).

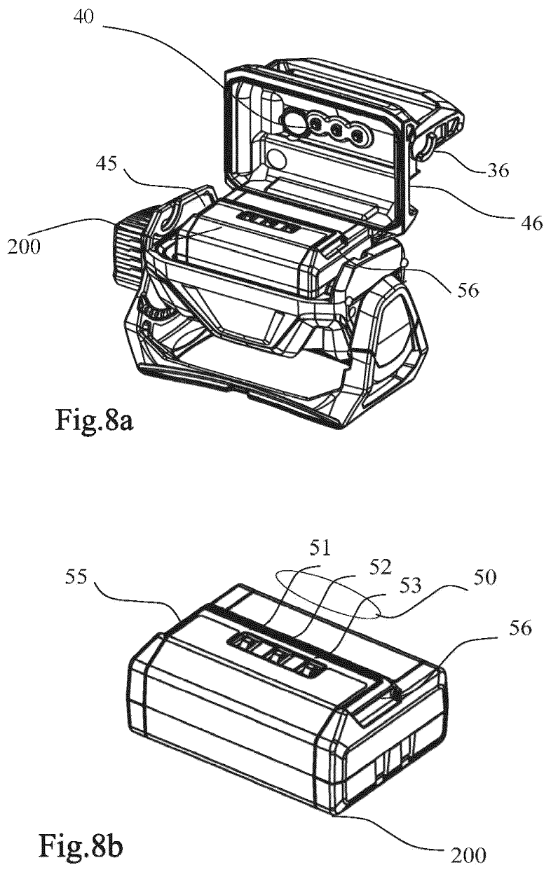

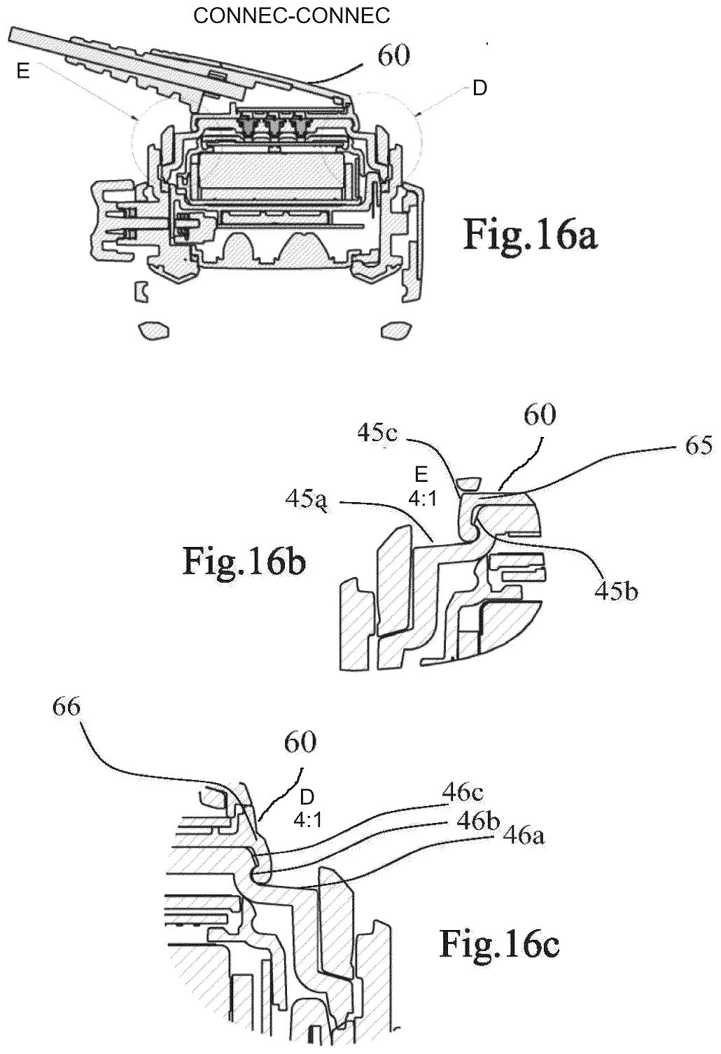

To allow the battery to be recharged even when it is inside the housing case, as shown in FIG. 8b but also in the detailed views of FIGS. 16b and 16c, each of the left and right side faces of the cover 20 has a recess allowing the positioning of a charging connector 60 having an appropriate hooking profile.

More specifically, as can be seen in the detail of FIG. 16b showing the left part of the hooking profile 45 of the upper left edge, the profile of the recess comprises two substantially flat surfaces 45a and 45c substantially forming a re-entrant angle, and which are connected by means of a semi-circular groove 45b parallel to the upper edge of the left lateral face. As can be seen in the detail of the section of FIG. 16b showing a connector 60 clipped onto the cover, the semi-circular groove 45b is configured to provide a support line for a cylindrical surface located at the end of the flexible jaw 65 of the connector in order to allow the latter to be clipped/unclipped onto the attachment profile. The unclipping of the connector is ensured by an elasticity of the two jaws allowing the cylindrical surface to come out of the corresponding semi-circular groove to move the connector apart.

Symmetrically, as seen in FIG. 16c, the right part of the hooking profile 46 of the upper right edge shows a recess comprising two substantially planar surfaces 46a and 46c connected by a semicircular groove 46b parallel to the groove 45b. Similarly to before, the hooking profile 46 is configured to provide a support line to a cylindrical surface located at the end of the jaw 66 of the connector 60 while also ensuring the locking/hooking of this jaw once in place.

Preferably, the battery 200 has exactly the same profile and configuration on its upper face, namely a three-pole connector 50 provided with three electrode terminals 51, 52 and 53 as well as hooking profiles/devices 55 and 56 identical to those which have just been described for the housing body 10, so that the same connector 60 can be attached to both the housing body 10 and the battery 200.

In this way, the user can recharge the battery either internally (i.e. housed in the housing body 10) or externally. With the advantage that a battery can be recharged at the same time as another battery is being used in the headlamp.

Two alternative embodiments of the electrical interface between the electrical connector 60 and the housing 10 or the battery 200 will now be described.

In a first preferred embodiment, the housing body 10 (resp. battery 200) comprises a first central terminal 41 (resp. 51), a second terminal 42 (resp. 52) and a third terminal 43 (resp. 53) arranged linearly and at equal distances and configured to allow an electrical connection with each of the three contacts of the connector 60.

The first and third electrical terminals 41 and 43 (resp. 51 and 53) are dedicated to the transmission of a positive electrical voltage/potential while the second electrical terminal 42 (resp. 52) is located at an equal distance from the left and right attachment profiles so as to allow a connection of the connector by the right or by the left.

In this first embodiment, the management of the temperature of the battery is carried out internally, inside the housing 10 (resp. battery 200).

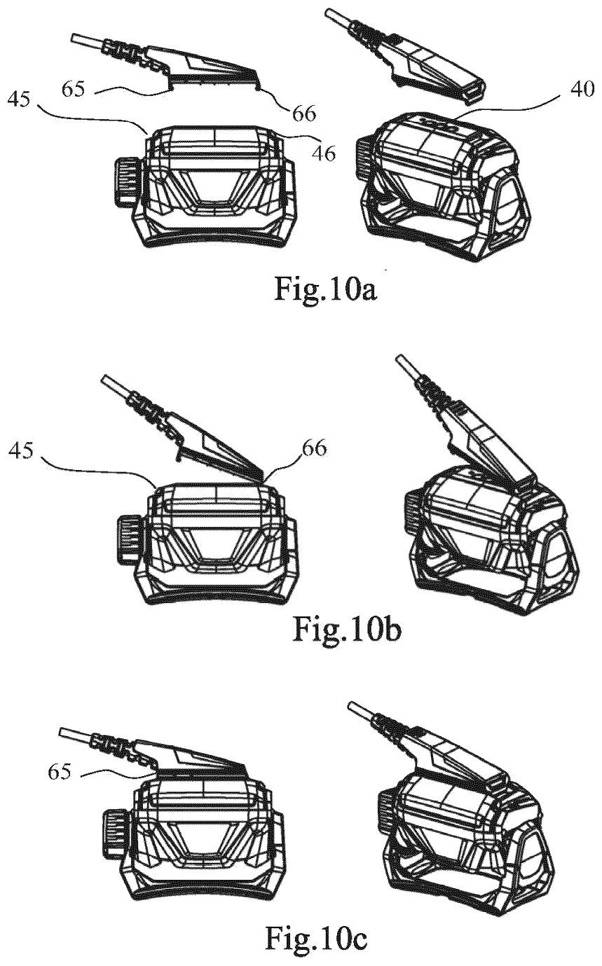

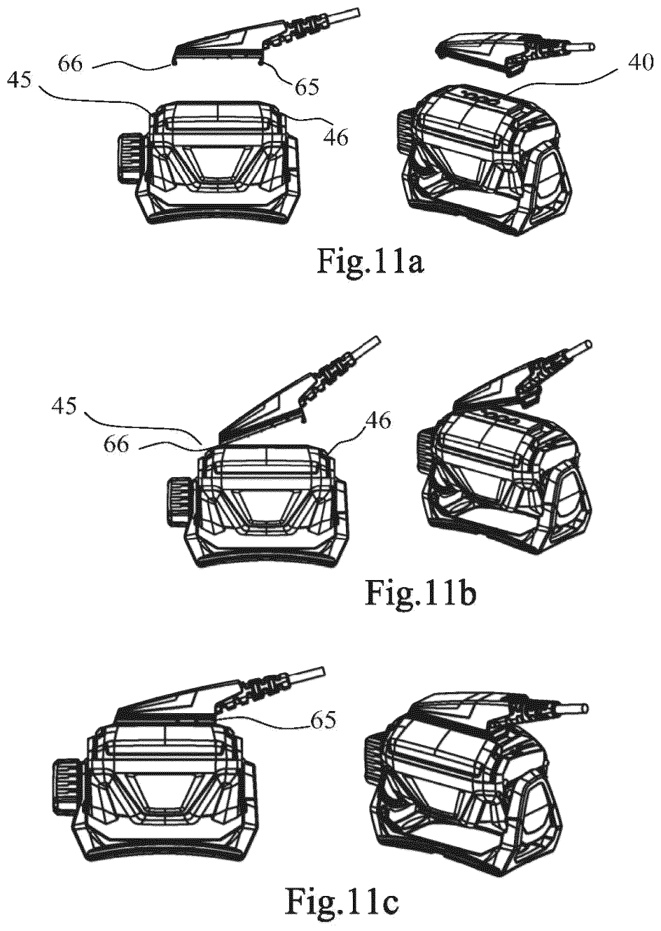

In a second particular embodiment, the connection device 40 of the housing body 10 (resp. battery 200) comprises a central electrode 42 (resp. 52) which is dedicated to the transmission of an electrical signal representative of the temperature of the battery. This arrangement proves to be very advantageous in that it allows the electronic battery management circuit to be relocated outside the housing and thus avoids having to evacuate intense heat generated inside a sealed housing, which could slow down the recharging process. In addition, since terminal 42 (or 52) is positioned exactly halfway between the two attachment profiles 45-46 (or 55-56), the transmission of the signal representing the battery temperature will be ensured regardless of the direction of connection of connector 60, from the left (FIG. 10a-c and 12a-c) or from the right (FIGS. 11a-c and 13a-c).

In a particular embodiment, the other two terminals 41 and 43 of the housing case 10 (resp. 51 and 53 of the battery 200) are dedicated to the coupling of two voltage/potentials, positive and negative, so that the connector 60, once clipped onto the housing/battery can provide two supply voltages, respectively positive and negative, for recharging the battery, while collecting the electrical signal on the terminal 42 (resp. 52) representative of the internal temperature of the battery.

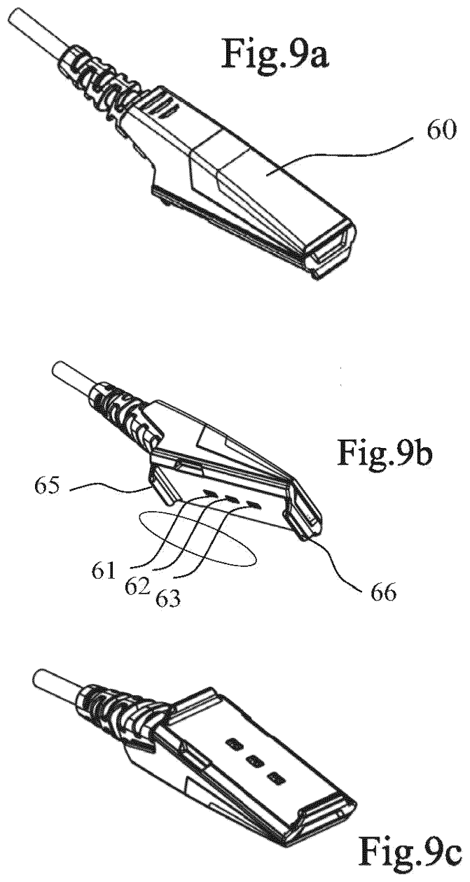

With reference to FIGS. 9a, 9b and 9c, a connector 60 configured to clip/unclip onto the housing 10 or directly onto the battery 200 using two upper 66 and lower 65 jaws specially configured to clip onto the hooking profiles/devices 45/46 of the housing case 10 (resp. 55/56 of the battery 200).

The connector 60 comprises a set of three contact electrodes 61-62-63 arranged linearly and in perfect agreement with the electrode poles 41-42-43 of the housing 10 (resp. 51-52-53 of the battery 200). In this way, the connector 60 can provide a supply voltage via the contacts 61 and 63, while recovering on the contact 62 a voltage/potential representative of the temperature of the battery.

Furthermore, to ensure perfect clipping, the upper 66 and lower 65 jaws comprise a cylindrical surface configured to take a support line on the corresponding fillets 45b/46b of the housing case 10 (resp. 55b/56b of the battery 200).

In a particular embodiment, the connector 60 is configured to be connected to a battery recharging system which comprises a system for automatically detecting the voltage/potential difference present between the terminals 61 and 63 when it is clipped onto the battery, and further comprises electronic switching circuits for providing a voltage/potential difference in harmony with the direction of the voltage difference detected on the terminals 41-43 of the housing 10 (resp. 51-53 of the battery 200). This allows for maximum simplified use for a user who then no longer has to worry about the direction of clipping of the connector 60—from the left or the right-on the upper face of the housing 10 or the battery 200.

Thus, as can be seen in the front view and the front perspective view of FIGS. 10a, 10b and 10c, the user can clip the connector 60 onto the housing 10 in a first direction in which the electrical cable of the connector is on its left.

On the contrary, as illustrated in FIGS. 11a, 11b and 11c, the user can also clip the connector 60 in the other direction, that is to say when the electrical cable of the connector is on its right.

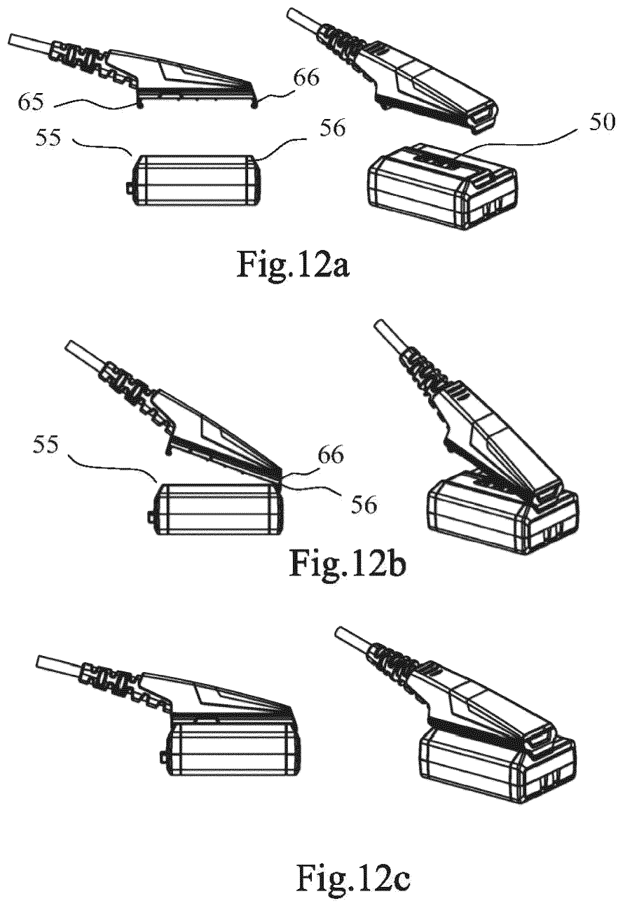

Similarly, FIGS. 12a, 12b and 12c illustrate the connection of the connector 60 directly onto the battery 200 from “the left”.

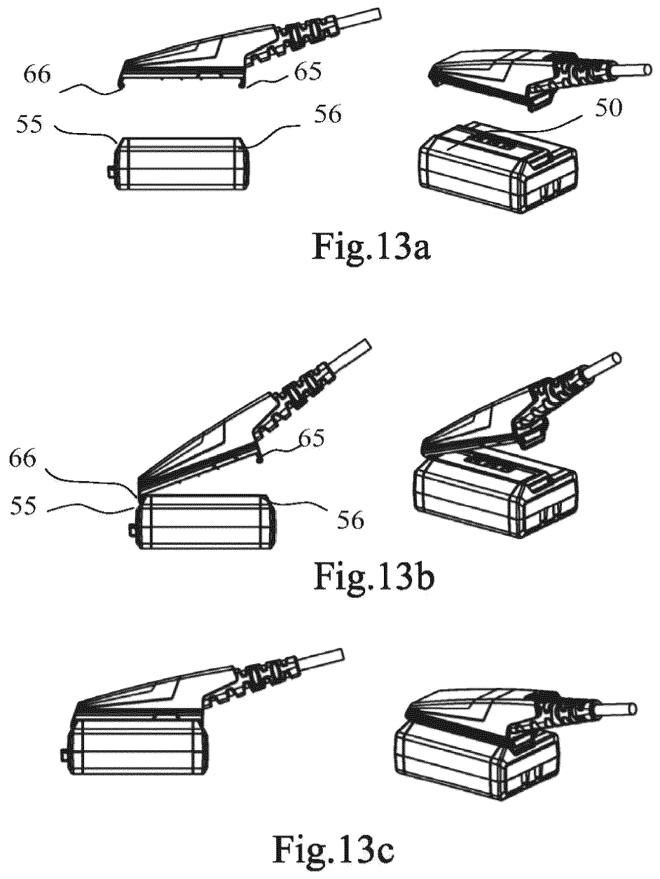

And FIGS. 13a, 13b and 13c illustrate this connection in the opposite direction, that is, from “the right”

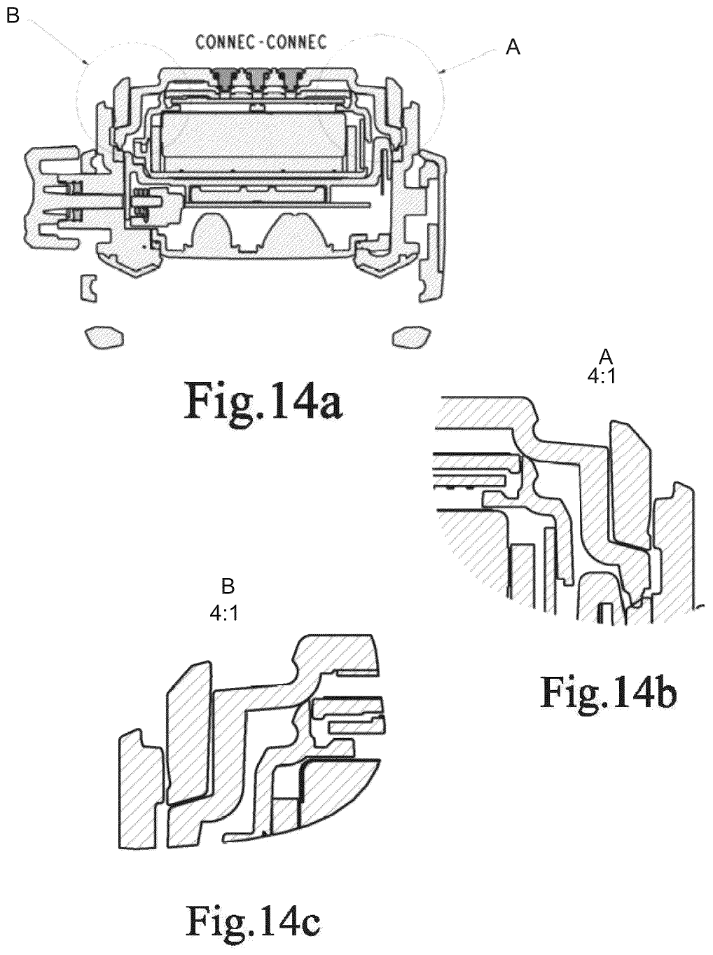

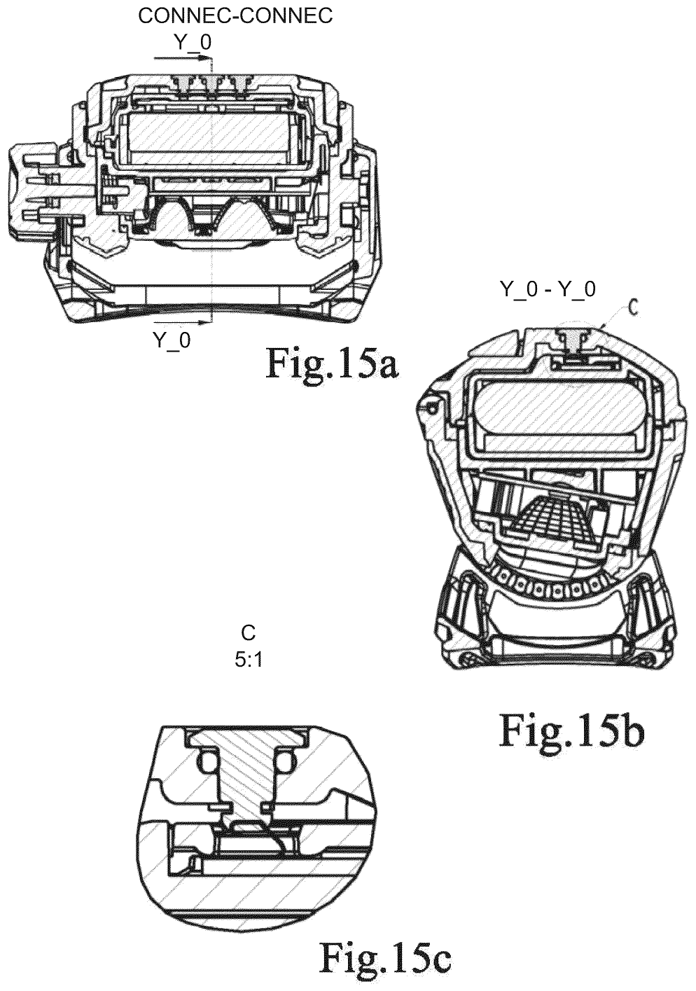

FIGS. 14a, 14b and 14c illustrate a section of the housing with the battery, as well as two detail views A and B, respectively, while FIG. 15a illustrates the CONNEC-CONNEC view of the housing with the battery, as well as the definition of a section Y_0.

Furthermore, FIG. 15b illustrates the section Y_0-Y_0 defined in FIG. 15a and FIG. 15c illustrates a detail C of FIG. 15b.

FIGS. 16a, 16b and 16c illustrate respectively a section of the connection connector connected to the housing with the battery, as well as two details D and E respectively.

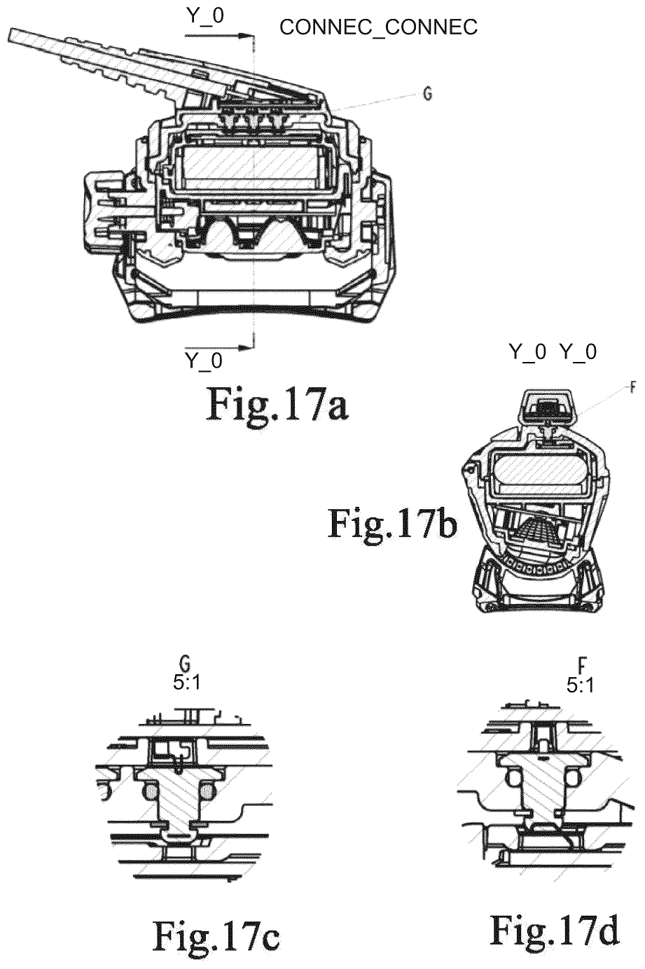

FIGS. 17a, 17b, 17c and 17d respectively illustrate the same sections as those of FIGS. 15a, 15b, and 15c, but with the connector connected to the battery housing, with two detailed views G and F.

As can be seen, the device that has just been described is very easy to use for the user who does not have to worry about the direction of clipping the connector onto the battery and who can choose to charge the battery directly outside the housing or when it is housed in the housing of the headlamp.

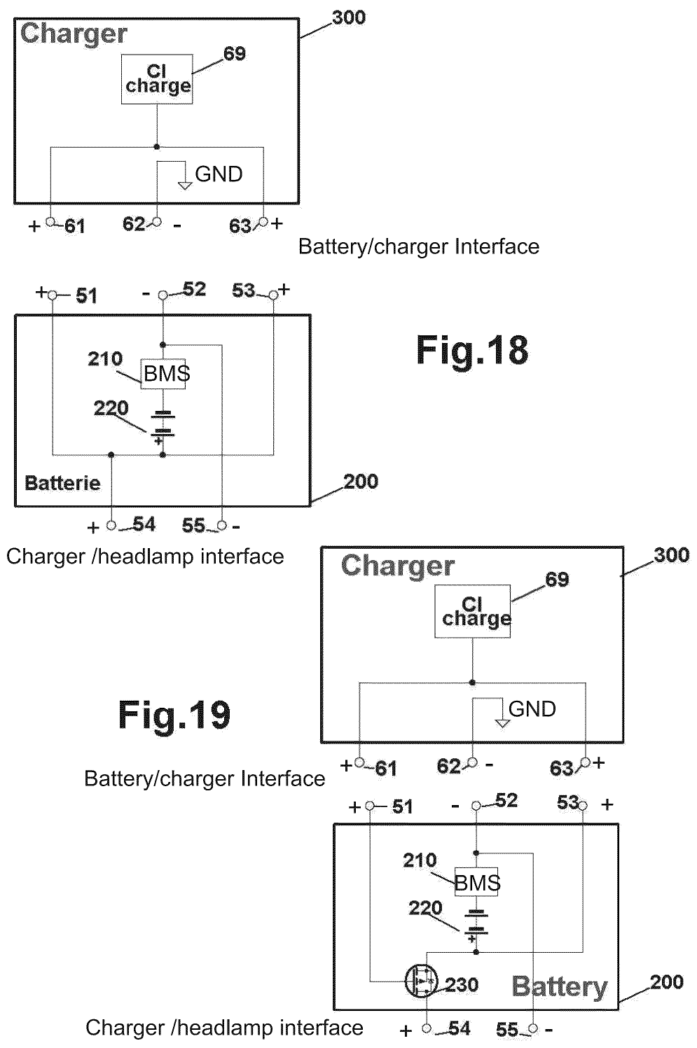

FIGS. 18, 19 and 20 illustrate three specific embodiments of the electronic circuits of the charging system and the battery.

FIG. 18 illustrates a first embodiment of the electronics associated with a charger 300 configured to recharge a battery 200, as described previously via a battery charger interface forming the electrical part of the connector 60 comprising the three electrodes 61, 62 and 63.

In this first embodiment, the charger 300 comprises an integrated recharging circuit 69 supplying power to the three poles 61, 62 and 63 of the connector 60 (not illustrated in FIG. 18) respectively receiving three voltages: positive, negative (ground) and positive.

Corresponding to the poles 61-62-63, the battery 200 comprises three poles 51, 52 and 53 ensuring the electrical coupling between the poles of the connector 60 and those of the battery, as well as two additional poles 54 and 55 providing the interface between the battery and the headlamp.

The electrical connections are made. The poles 51, 53 and 54 are coupled together and carry the positive voltage/potential. Pole 52 is coupled to pole 55 as well as to a first electrode of a BMS battery management circuit 210, a second electrode of which is connected to a first electrode of an energy cell 220. The cell 220 has its second electrode connected to poles 51, 54 and 55. The BMS circuit 210 is located as close as possible to the energy cell 220 to ensure adequate protection.

As can be seen, the circuit of FIG. 18 produces a symmetrical connector whose reversibility function is ensured by the positive poles 51 and 53 which are symmetrically and positioned on either side of the central contact-produced by pole 52.

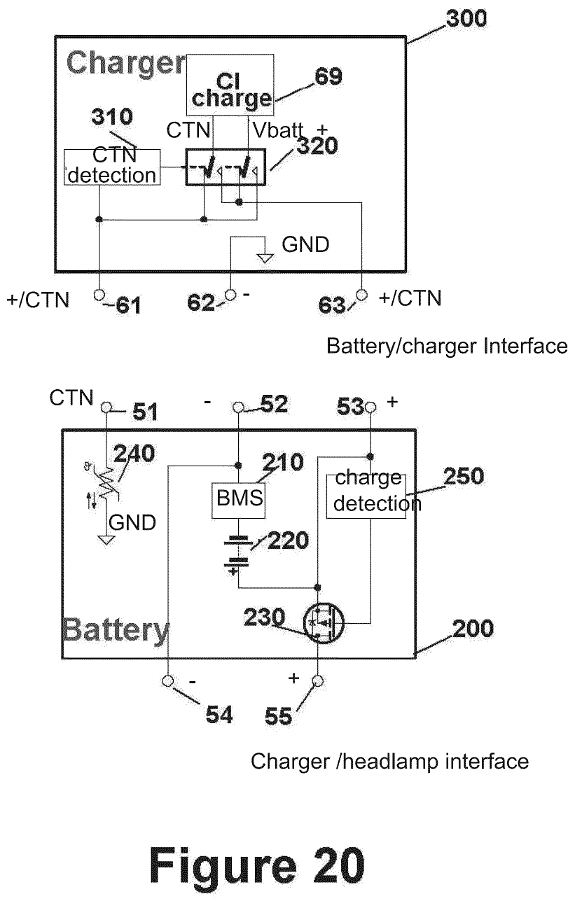

In more advanced embodiments which will be described in relation to FIGS. 19 and 20, it is proposed to add additional functionalities and this, in a very advantageous manner, without adding additional poles.

The elements of FIGS. 19 and 20 that are common with those of FIG. 18 will keep identical references.

FIG. 19 shows a second embodiment having a charger identical to that of FIG. 18. On the other hand, the battery 200, if it still has a set of three poles 51-52-53 and two poles 54-55, respectively at the interface with the charger and with the headlamp, now integrates a MOS transistor 230 having a gate, a source and a drain respectively coupled to the poles 51, 53 and 54. As previously, the circuit 210 and the energy cell 220 are connected in series between the poles and 53.

Because of this arrangement, the charger keeps a symmetrical construction, the positive terminals are identical but the functionalities of the two contacts facing each other on the battery side are used differently. Reversibility is ensured by ensuring that the function is provided in the voltage range supplied on a + terminal of the charger. The function sought in this second embodiment is the disconnection of the L-contact (towards the headlamp) by the mosfet when the charger is connected. As can be seen, the lamp cannot therefore be used during charging. The advantage presented by this second embodiment is the use of 3 poles (+, −, +) on the charger side for 3 different contacts on the battery side without increasing the number of contacts.

FIG. 20 illustrates a third embodiment in which new components are introduced both in the charger 300 and in the battery 200.

Indeed, the charger 300 now comprises, in addition to the integrated charging circuit 69, a circuit for detecting an NTC temperature sensor 310 and a switching circuit 320. The NTC detection circuit 310 comprises two electrodes, namely a first electrode connected to the pole 61 to detect the presence of a signal representative of an NTC temperature, as well as a second electrode allowing the transmission of a control signal to the switching circuit 320. The charging circuit 69 is coupled via two electrodes to the switching circuit 320, which is also coupled to the two poles 61 and 63. Depending on the control signal transmitted by the NTC circuit 310, the switching circuit 320 can invert the poles 61 and 63 to ensure the reversibility of the coupling of the connector 60. The pole 62 is, for its part, coupled to ground.

The battery 200 comprises, in series between the poles 52 and 55, a battery management circuit 210, an energy cell 220 and a MOSFET transistor 230. The pole 54 is also connected to the pole 52 carrying the ground.

A charge detection circuit 250, connected to the pole 53 and coupled to the gate of the MOSFET 230, detects the presence of the charging connector in order, if necessary, to authorize or not the passage of current coming from the energy cell 220 and, thus validate the use of the battery.

Finally, the battery 200 includes a CTN resistor 240 coupled between the ground and the pole 51 so as to transmit, via the latter, information representative of the temperature of the energy cell. It is this information that, precisely, the circuit 310 of the coupler detects to transmit it to the charging circuit.

This third embodiment has significant advantages.

Indeed, in order to optimize the charging and safety of the battery according to the temperature (in addition to the protections of the BMS) it is important to send the temperature information back to the charger. However, as mentioned above, it is desirable not to add an additional pair of contacts to the connector 60. Consequently, the third embodiment achieves this goal by using only 3 different contacts NTC, −, + respectively on the poles 51, 52 and 53. Reversibility is ensured by means of an assignment of the functionalities: here function+ and function NTC by the detection of the contacts present opposite one of the pins/poles of the charger.

When connecting the charger to the battery, the NTC detection circuit 310 will detect or not the presence of the battery's NTC. Depending on that detection, switch block 320 (analog switch) is controlled so as to assign the NTC and VBATT+ functions of the circuit 69 to the correct poles/contacts of the reversible connector 60.

Furthermore, the function that was already present in the second embodiment is also present in this third embodiment: namely the disconnection of the battery on the lamp side in the event of recharging. This function is performed in the third embodiment by means of the presence of the charger voltage on the + terminal alone. The block 250 controls the mosfet 230 allowing the signal to be cut on the pole 55 (L+) and avoids edge effects (feedback of the cell voltage to the mosfet input).

What is claimed is:

1. A device for connecting a battery charging system comprising:
a connector (60) provided with three electrical contacts arranged linearly and further comprising two flexible jaws having at their end a cylindrical surface intended to clip onto the upper part of a battery (200); wherein said connector comprises a first (61), a second (62) and a third (63) electrical contact arranged linearly and the second contact (62) being arranged at an equal distance from the two jaws; and
a battery (200) comprising two left and right side faces each comprising a recess with a hooking profile (55, 56) configured for a corresponding jaw of said connector (60), said battery (200) comprising a first electrode terminal (51), a second electrode terminal (52) and a third electrode terminal (53) arranged linearly and configured to allow an electrical connection with each of the three contacts (61, 62, 63) of said connector (60), and
wherein the profile of each of said recesses comprises two substantially planar surfaces substantially forming a re-entrant angle, and which are connected by means of a semi-circular groove (55b) whose generating axis is parallel to the upper edge of the left side face, wherein said semi-circular groove (55b) provides a support line for said cylindrical surface of a corresponding jaw, so as to allow clipping of the connector;
wherein the first and third electrical terminals (51, 53) are dedicated to the transmission of a first electrical voltage/potential and wherein the second terminal (52) is located at an equal distance from the left and right hooking profiles so as to allow connection of the connector from the right or from the left and is furthermore dedicated to the transmission of a second electrical voltage/potential.

2. A connection device according to claim 1 wherein the second terminal (52) is configured to transmit a negative voltage while the first and third terminals (51, 53) are configured to transmit a positive voltage.

3. A connection device according to claim 1, in which the first or second terminal is configured to transmit to a charger a voltage representative of the temperature of the battery; and
wherein the other two terminals are then configured to transmit two positive and negative voltages.

4. A connection device for a battery charging system housed in a housing case (10) of a headlamp comprising:
a connector (60) provided with three electrical contacts arranged linearly and further comprising two flexible jaws having at their end a cylindrical surface intended to clip onto a housing case (10) of a battery (200); in which said connector comprises a first (61), a second (62) and a third (63) electrical contact arranged linearly and the second contact (62) being arranged at an equal distance from the two jaws; and
a housing case (10) for a battery (200) having two left and right side faces each comprising a recess with a hooking profile (45, 46) configured for a corresponding jaw of said connector (60), said housing case (10) having a first electrode terminal (41), a second electrode terminal (42) and a third electrode terminal (43) arranged linearly and configured to allow an electrical connection with each of the three contacts (61, 62, 63) of said connector (60); and
wherein the profile of each of said recesses comprises two substantially flat surfaces substantially forming a re-entrant angle, and which are connected by means of a semi-circular groove 45b whose generating axis is parallel to the upper edge of the left lateral face, wherein said semi-circular groove (45b) provides a support line for said cylindrical surface of a corresponding jaw, so as to allow clipping of the connector;
wherein the first and third electrical terminals (41, 43) are dedicated to the transmission of a first electrical voltage and wherein the second terminal (42) is located at an equal distance from the left and right attachment profiles so as to allow connection of the connector from the right or from the left and is also dedicated to the transmission of a second voltage.

5. The device according to any one of claim 1, in which the connector (60) is configured to be able to be connected indifferently in one direction or the other relative to the battery (200) or to the housing case (10).

6. A connection device according to claim 4, in which the second terminal (42) is configured to transmit a negative voltage while the first and third terminals (41, 43) are configured to transmit a positive voltage.

7. A connection device according to claim 4, in which, the first or second terminal (41, 42) is configured to transmit to a charger a voltage representative of the temperature of the battery; and
in which the other two terminals are then configured to transmit two positive and negative voltages.

8. The connection device according to claim 4, wherein the battery housing case comprises:
a case body (10) comprising a front face (11), a rear face (12) and two left and right side faces (13, 14),
wherein said rear face (12) comprises a hinge (19) allowing the rotation of a cover 20 relative to a first axis of rotation substantially parallel to the upper rear edge;
wherein each of the left and right side faces (13, 14) comprises, at the front part of said case, a groove of substantially circular shape (15, 16) centered on a point defining a second axis of rotation;
said case cover (20) comprises an upper face, two left and right side faces and a rear side face,
wherein said rear side face comprises a pivot connection allowing the rotation of the cover about said first axis;
wherein said cover (20) comprises respectively on the left and right side faces a blind hole (23, 24) materializing said second axis of rotation, and configured to receive two pins (33, 34) located on the two ends of a U-shaped lever (30) so as to allow its rotation about the second axis of rotation,
said U-shaped lever (30) comprising two left (31) and right (32) branches,
wherein the inner face of the left branch (31) comprises a first perpendicular pin (33) and the inner face of the right branch (32) comprises a second pin (34);
wherein said first and second pins (33, 34) are configured to be inserted into said blind holes (23, 24) of said cover (20) so as to complete a pivot connection of said lever (30) relative to said cover (20) about said second axis of rotation;
wherein said U-shaped lever (30) further comprises, on each of the two external faces of the left and right branches (31, 32), a cam (35, 36) having a substantially circular shape centered around said second axis of rotation;
wherein said lateral faces (13, 14) of said housing (10) comprise, at the front part, two circular grooves (15, 16) centered around the second axis of rotation, and configured to receive the engagement of said circular cams (35, 36), respectively, when the cover is in the closed position with the lever in the deployed position and the lever is pivoted to insert the circular cams (35, 36) into their respective circular grooves (15, 16) ensuring force locking.

9. The charging device according to claim 8, wherein said housing comprises at the middle of the left and right side faces two pivot elements (17, 18) producing a third axis of rotation around which the housing can describe a rotational movement relative to a fixed support.

10. The charging device according to claim 9, wherein said lever (30) is configured so as to perfectly match the shape and profile of said cover (20) when the latter is in the finalized locking position.

11. The charging device according to claim 10, wherein the housing produces an external battery housing case allowing the remote power supply of a headlamp.

12. A device for recharging a battery for a headlamp in which the recharging system comprises a connection device as defined in claim 3, and in which the charging system further comprises electronic circuits for automatically detecting the direction of the voltage difference present on the first and third electrode terminals (41, 43) and switching circuits for adapting the direction of the voltage to be applied to said first and third contacts (61, 63).

13. A headlamp having a power supply unit adapted for recharging by a recharging device as defined in claim 1.

14. An electric battery for powering a portable lamp, configured to be recharged by the recharging device as defined in claim 1.
